(19) United States
(12) Patent Application Publication
(10) Pub. No.: US 2007/0156855 A1
(43) Pub. Date: Jul. 5, 2007

(54) Channel searching media player

(76) Inventor: Moses Johnson, Philadelphia, PA (US)

Correspondence Address: Rutan & Tucker, LLP.;Hani Z. Sayed, 611 ANTON BLVD, SUITE 1400, COSTA MESA, CA, 92626, US

(21) Appl. No.: 11/471,353

(22) Filed: Jun. 19, 2006

Related U.S. Application Data
(60) Provisional application No. 60/692,070, filed on Jun. 17, 2005.

(51) Int. Cl. G06F 15/16

(52) U.S. Cl. 709/219

(57) ABSTRACT

Software coordinates or otherwise provides for resolving a media search request, providing a user with a results set taken from at least one peer-to-peer file indexer, and obtaining the media, all without the burdens attendant upon actually running one of the peer-to peer clients. The software is particularly useful when obtaining and playing BitTorrent and Gnutella files according to given genre or channel. Physical devices that run the coordinating software can be quite small, including for example many PDAs and advanced cell phones that communicate wirelessly.

This application claims priority to U.S. provisional application Ser. No. 60/692,070 filed Jun. 17, 2005.

### FIELD OF THE INVENTION

The field of the invention is interactive video and other media distribution processes and systems that provide media at the request of a user (class 725/87).

### BACKGROUND

There are numerous websites that host pay-as-you go distribution systems. Some of the more popular sites are Movielink™ and CinemaNow™ for downloading videos, and Naptster™ for music downloads. These systems are typically point-to-multipoint configurations used for the unidirectional distribution of proprietary content.

Although there is an enormous amount of proprietary content available on the web, there has also been a virtual exposition of free content available from individual posting their own videos, images, music, image, stories, blogs and so forth. Some of the free content is available from centralized servers, (e.g. as Vivmeo™, Vsocial™, Grouper™ and YouTube™), but most of the content is handled by peer-to-peer file sharing protocols such as Gnutella and BitTorrent. For useful discussions of those protocols, see the respective Wikipedia articles at http://en.wikipedia. org/wiki/Gnutella and http://en.wikipedia.org/wiki/Bittorrent.

Securing media from the centralized server systems is relatively straightforward, because the systems compete with each other for convenience. But securing media stored on the peer-to-peer file sharing systems is awkward. Among the many problems is that in the wake of Napster's legal battles when it was a rouge purveyor of illegal content, the remaining peer-to-peer systems widely distribute the content and avoid any sort of centralized index that could be attacked by the authorities. For example, in downloading a BitTorrent file, a user must typically execute all of the following steps: (1) contact one the BitTorent trackers (e.g. Bittorrent.com™, Torrentspy™, Isohunt™, Mininova™, and Torrentportal™); (2) download the torrent; (3) use one of the BitTorent clients (e.g., bittorent-stable, BitTomado™, Azureus™, ABC™, burst!™ to use the torrent to access the file; (4) locate and apply an appropriate password for encrypted files; (5) find an appropriate media player to play the media; and (6) manage the downloaded files on whatever memory they are stored. Thus, even though Wikipedia™ estimates that 40% of all web traffic comprises BitTorrent files, downloading and playing such files can be quite difficult.

Downloading Gnutella files is even more problematic. There, instead of using a BitTorrent tracker, one would need to use an index from one of the ultrapeers such as BearShare™, and then use one of the Gnutella clients such as BearShare, Gnucleus™, LimeWire™, Phex™, Swapper™, and XoloX™ to actually download the file. In addition, a user would need to allow his own computer to store files and act as a server for downloads by other users.

There are other problems as well. Many hand-held devices such as PDAs and high end cell phones cannot be used effectively to run the BitTorrent clients, or to act as a Gnutella server, so that if one wanted to play the media on his PDA, one would need to download the files. Therefore one would need to use a desktop or laptop computer with a fast connection to download the file, and then copy the downloaded files to the PDA to play them. Another problem is that many firewalls will block peer-to-peer access, and users may not be sophisticated enough to unblock particular ports (Azureus requires port 48406 to be unblocked). Still another problem is that the various tracker and ultrapeer sites compete with each other for media, so that even if one of those sites were to provide an integrated service, searches of media on that site would be limited to the offering of that particular site.

There are, of course, systems that maintain playlists, and download new content to those playlists. Microsoft Windows Media Player™, for example, uses Seekmo™ to search for and download material from centralized server locations (for a fee), and organize those materials for playback on a user's computer. U.S. Pat. No. 6,526,411 (Ward, February 2003) teaches another system that maintains a database of linkages to various media files that can be distributed throughout the web, and provides searching for those files using a collaborative filtering index. Neither of those systems, however, provides a coordinated solution for obtaining files stored on distributed file sharing systems.

In 1991 the Register™ reported that the International Federation of the Phonographic Industry (IFPI) had developed and deployed a program that mimicked many of the clients used to share music. http://www.theregister.co.uk/2001/03/22/music industry tracking individual mp3/ The program, known as Media Tracker, apparently built up lists of tracks, the networks they were being shared on (Napster, Freenet, Gnutella etc), the sharer's IP address and the name of their host or ISP. Media Tracker was presumably searchable, but the step of obtaining the media identification information was not done in response to the search request.

The '411 patent, the Register article, and all other referenced extrinsic materials are incorporated herein by reference in their entirety. Where a definition or use of a term in an incorporated reference is inconsistent or contrary to the definition of that term provided herein, the definition of that term provided herein applies and the definition of that term in the reference does not apply.

In short, despite numerous developments in the field, users still need software that provide for all of the steps needed identify and obtaining the media, all without the burdens attendant upon actually running one of the peer-to-peer file sharing clients, manipulating the files, and locating appropriate players.

### SUMMARY

The present invention provides systems, methods, and devices that coordinate the steps of resolving a media search request, providing a user with a results set taken from at least one file indexer, and obtaining the media, all without the burdens attendant upon actually running one of the peer-to peer clients.

In preferred embodiments the software obtains a search request in the form of a search string having a word or series of words, and possibly using Boolean logic. The search request is preferably resolved using one or more parsing techniques to obtain a search value, and might further be resolved by downloading metadata from the file indexer, and then filtering the metadata for the search value.

The metadata can be secured from a single file indexer, at different time from different indexers, or from concurrently from multiple indexers. Such metadata can be presented “as is” to a user, or combined or otherwise massaged in some manner to present choices to a user. Choices preferably include at least one of a name of an author, a title of a work, a subject matter designation, and a genre designation, and are preferably organized according to channels. Choices can advantageously be presented to the user using thumbnails or other aspects of a rich media interface.

Once a choice is made, accessing information is obtained from the indexers(s). The accessing information can point to a torrent, a node of a decentralized file sharing system, a centralized file sharing source, or any other suitable source. The media is usually downloaded on demand, but updates can be sought periodically on an ongoing basis.

In preferred embodiments the software automatically chooses an appropriate media player to play the downloaded media. This might include, for example, XviD or DivX to play high definition files that are common with BitTorrent files. Such play also preferably involves use of a jitter buffer, so that the file can begin playing before it is fully downloaded.

The software can optionally handle aspects of the file maintenance, including for example: organizing the files; automatically replacing older versions with newer versions; deleting fragments or entire files after they are played; and removing older files from the memory to make room for newer files.

Physical devices that run the coordinating software can be quite small, including for example many PDAs and advanced cell phones that communicate wirelessly. Among other things this is because the software can “coordinate” the various listed functions by performing those functions itself, by triggering some other software or hardware to perform those functions, or any combination thereof. Such powerful functionality on a small device with relatively low processing capability can also result from operating all of the functions from with a media player application.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a schematic of a media search and retrieval system in accordance with various aspects of the inventive subject matter.

FIG. 2 is a schematic of a PDA that runs software according to various aspect of the inventive subject matter.

### DETAILED DESCRIPTION

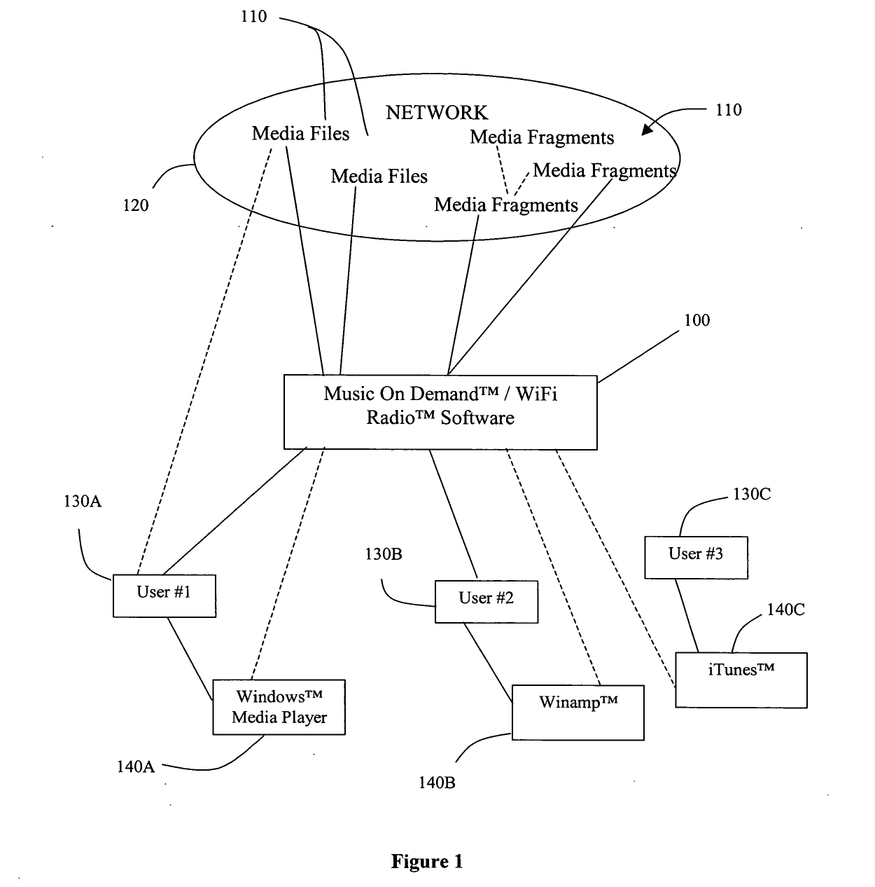

Referring first to FIG. 1, software 100 collects links to files 110 (which may or may not be in fragments) existing on the World Wide Web and/or other networks, all of which are generically shown here as a cloud 120. Exemplary software are Music On Demand™ and WiFi Radio™, both from Advance Theory™. The software provides users 130A, 130B, 130C with files downloaded from the network 120, and either directly executes, or at least provides for execution of, the downloaded media using one or more of media players 140A, 140B, 140C. The various connection lines denote communications, with the dashed lines denoting optional communications.

The MOD database is a dynamic database of media files found within the World Wide Web and elsewhere. When a user searches for a media file (e.g. song, picture, moving picture, and so on), the links on the MOD database are searched, and a playlist based on the search criteria is returned to the user. When the user selects and item from the list, the system downloads the item, and launches the relevant file(s) in an appropriate media player. It should be recognized that a user may initiate a search using his media player and upon retrieval of the media file (or link), the media player can automatically begin to play the media file. Thus, consumption of the media can be immediate and continual. All suitable media players are contemplated, including for example Windows Media Player™, iTunes™, and Winamp™.

In another aspect, the MOD database also comprises links to ads which can be integrated into a playlist thereby simulating a television or radio experience. It is contemplated that selling of ads to be inserted into the playlists may provide a revenue source to content providers.

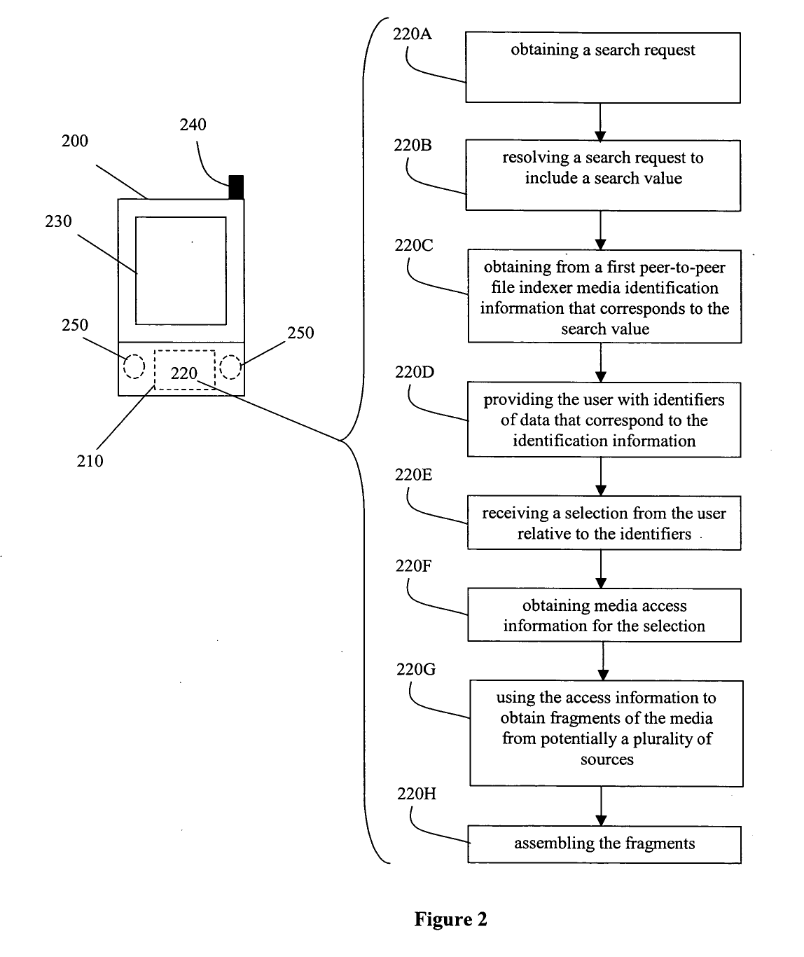

In FIG. 2, a PDA 200 contains a processor 210 that runs software 220 located on a memory. Interactive display screen 230 provides input to, and visual output from the PDA, respectively, and antenna 240 allows the PDA to operate wirelessly. Speakers 250 provide output of music and other sounds.

In particularly embodiments the software obtains a media item from an interactive media distribution system at the request of a user pursuant to the following steps: obtaining a search request (220A); resolving the search request to include a search value (220B), and then obtaining from a first peer-to-peer file indexer media identification information that corresponds to the search value (220C); providing the user with identifiers of data that correspond to the identification information (220D); receiving a selection from the user relative to the identifiers (220E); obtaining media access information for the selection (220F); using the access information to obtain fragments of the media from potentially a plurality of sources (220G); and assembling the fragments (220H). Those of ordinary skill in the art will appreciate that the job of the software in coordinating these steps can comprise the software triggering other programs that execute one or more of the steps, the software executing one or more of the steps itself, and any combination of these. In keeping with that perspective, references below indicating that the software “provides for” a given outcome or functionality should be interpreted to mean that the software either includes code to produce the outcome or perform the functionality, or that the software engages some external code to produce the outcome or perform the functionality, or some combination of the two.

In step 220A, the software provides for obtaining a search request. A search request would ordinarily comprise keywords and Boolean symbols, but can additionally or alternatively include a color, image, sound, and so forth. The request can be obtained from the user in any suitable manner, directly or indirectly, and can include any suitable type of request. For example, requests can be spoken words (through microphone not shown), or written words (entered on the display screen 230 or through a thumb pad). The search request, or a portion of it, could even be brought in from a file local to the device, or from any other accessible source, or for example, the secured by the user selecting an item from at least one of a list of media titles, a list of authors, and a list of genres.

In step 220B, the software provides for resolving a search request to include a search value. Resolution of the request can occur in any suitable manner, including for example, by parsing the search request.

In step 220C the software provides for obtaining from a first peer-to-peer file indexer media identification information that corresponds to the search value. The media identification information would typically be downloaded from a website hosted by, controlled by, or operated for the benefit of the indexer. Contemplated file indexers include nodes of decentralized file sharing systems, (e.g. Torrentspy™, Isohunt™, Mininova™, and Torrentportal™ file trackers), as well as indexes from Gnutella ultrapeers (e.g., Bearshare™). The file indexer can use any suitable protocol for finding nodes that contain at least one of the fragments, including for example a distributed hash table.

It is also contemplated that the software can provide for obtaining additional media identification information from a second file indexer that indexes files stored using a protocol that is different from that used by the first file indexer. Thus, the software might scrape several trackers to answer a given search, or more preferably might rotate or randomly select among various trackers to find information to answer the search. The system might even use a distributed file sharing index for some of the information, and a centralized index. (e.g. a Usenet index., http://www.ngindex.com/ib/, or Napster) as for other information.

It is especially contemplated that the system can provide for obtaining metadata from the file indexer, and obtaining the media identification information by filtering the metadata for the search value. Especially useful metadata include a name of an author, a title of a work, a subject matter designation, and a genre designation. The system can also provide for obtaining metadata from the file indexer, identifying additional metadata logically associated with the metadata, and then filtering the additional metadata for the search value. For example, if a user entered the search term “Miazaki”, the system might discover that Miazaki is the author of several anime films, and search not only for the name Miazaki, but also for the name Totoro.

In step 220D the software provides for showing a list of identifiers to the user, which identifiers correspond to the identification information. This would typically be achieved by listing selections in a window available to the user, with the selections preferably including at least one of a name of an author, a title of a work, a subject matter designation, and a genre designation. It also contemplated, however, that the identifiers could include a thumbnails or other images, sound, and even short video segments.

In step 220E the software provides for receiving a selection from the user relative to the identifiers. This could be accomplished in any suitable manner, including for example receiving a voice command, but is probably best accomplished by the user using a mouse or other pointing device to click on a virtual button.

In step 220F the software provides for obtaining media access information for the selection. The media access information would usually be obtained in response to receiving the search request, but could alternatively or additionally be obtained periodically on an ongoing basis.

In step 220G the software provides for using the access information to obtain fragments of the media from potentially a plurality of sources. Such access can occur by following out direct references, which specify a file or fragment location, and/or indirect references, which themselves must be resolved in some manner. Indirect references, for example, may need to be resolved using a distributed hash table.

In step 220H the software provides for assembling the fragments. Such assembly preferably occurs automatically, although assembly may be limited to storing the fragments in a directory or other area such that they can be readily found by the user. In most cases the fragments would be stored in a local or distant memory at least partially under the control of the user, and in the event that the media is being played before it is fully downloaded would involve storing at least some at least one of the fragments in a jitter buffer.

It is also contemplated that identifiers can be sorted according to channels, and that the channels can be periodically updated for new content to be downloaded. Thus, a user might be interested in hearing recent broadcasts of the Randy Rhoades Show™ on Air America Radio™, and might download and listen to a specific broadcast. But the system could also provide for identifying the show as a Channel, and automated daily searching and downloading of subsequent broadcasts of the show. Other criteria could also be employed, for example downloading new content at least partially as a function of evidence of popularity, size or file type of the new content. It is still further contemplated that the system could provide for automatic deletion of files or fragments, including for example, use of an expiration protocol that removes from the memory older media to make room for newer media, automatically deleting from any local memory each of the fragments after each such fragment is played, and automatically deleting the entire media item from any local memory after the item is played.

The system could also provide for automatically associating the media with an appropriate media player and operating the media player to play the media. Suitable media players include Windows™ Media Player, Real Player™, Winamp™, and Wifi Radio™ Media Player. Among other things, a user could select a channel, download and listen to music of a given genre all day, never have to concern himself with any specific files, and then at the end of the day the user would not have a single one of the played files on his system.

It is still further contemplated that some or all of the various steps of 220A-220G could be executed from within a media player. Indeed, that media player could be operated on a portable device, including a device that uses an antenna to obtain at least one of the media identification information and the fragments.

Thus, specific embodiments and applications of media search and retrieval systems have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A software program that provides for all of the following steps in obtaining a media item from an interactive media distribution system at the request of a user:
resolving a search request to include a search value, and then obtaining from a first peer-to-peer file indexer media identification information that corresponds to the search value;
providing the user with identifiers of data that correspond to the identification information;
receiving a selection from the user relative to the identifiers;
obtaining media access information, and using the access information to obtain fragments of the media from potentially a plurality of sources; and
assembling the fragments.

2. The software of claim 1, wherein the step of resolving the search request comprises obtaining a search string from the user.

3. The software of claim 1, wherein the step of resolving the search request comprises the user selecting an item from at least one of a list of media titles, a list of authors, and a list of genres.

4. The software of claim 1, further comprising obtaining metadata from the file indexer, and filtering the metadata for the search value.

5. The software of claim 4, wherein the metadata comprises at least one of a name of an author, a title of a work, a subject matter designation, and a genre designation.

6. The software of claim 1, further comprising obtaining metadata from the file indexer, identifying additional metadata logically associated with the metadata, and filtering the additional metadata for the search value.

7. The software of claim 1, wherein the file indexer comprises a file tracker.

8. The software of claim 1, wherein the file indexer points to a node of a decentralized file sharing system.

9. The software of claim 1, wherein the file indexer uses a distributed hash table to find a node that contains at least one of the fragments.

10. The software of claim 1, further comprising obtaining additional media identification information from a second file indexer that indexes files stored using a protocol that is different from that used by the first file indexer.

11. The software of claim 10, wherein the protocol used by the second file indexer comprises a centralized index.

12. The software of claim 1, wherein the step of obtaining the media access information is performed in response to receiving the search request.

13. The software of claim 1, wherein the step of obtaining the media access information is performed periodically on an ongoing basis.

14. The software of claim 1, wherein the step of obtaining the media identification information comprises downloading the information from a website.

15. The software of claim 1, wherein at least one of the identifiers include at least one of a name of an author, a title of a work, a subject matter designation, and a genre designation.

16. The software of claim 1, wherein the step of providing a user with identifiers of data comprises displaying image thumbnails to the user.

17. The software of claim 1, wherein the step of obtaining fragments comprises obtaining the fragments using a direct reference.

18. The software of claim 1, wherein the step of obtaining fragments comprises obtaining the fragments using an indirect reference.

19. The software of claim 18, wherein the indirect reference comprises a distributed hash table.

20. The software of claim 1, further comprising storing at least one of the fragments in a memory.

21. The software of claim 1, wherein the memory comprises a jitter buffer.

22. The software of claim 20, further providing organization of the identifiers according to channels.

23. The software of claim 20, further providing periodic checking of the channels for new content to be downloaded.

24. The software of claim 23, further providing for downloading of the new content at least partially as a function of evidence of popularity of the new content.

24. The software of claim 20, further providing an expiration protocol that removes from the memory older media to make room for newer media.

25. The software of claim 1, further providing automatically associating the media with an appropriate media player and operating the media player to play the media.

26. The software of claim 1 further providing automatically deleting from any local memory each of the fragments after each such fragment is played.

27. The software of claim 1 further providing automatically deleting the media from any local memory after the media item is played.

28. A media player that executes at least some of the steps of claim 1.

29. A physical device that executes the software of claim 1, comprising an antenna that can be used to obtain at least one of the media identification information and the fragments.
